(19) United States
(12) Patent Application Publication
(10) Pub. No.: US 2011/0206222 A1
(43) Pub. Date: Aug. 25, 2011

(54) MEMBRANE FOR AN ACOUSTIC TRANSDUCER

(75) Inventors: Susanne Windischberger, Vienna (AT); Gholamali Haddad, Vienna (AT)

(73) Assignee: NXP B.V., Eindhoven (NL)

(21) Appl. No.: 13/055,938

(22) PCT Filed: Jul. 28, 2009
(86) PCT No.: PCT/IB2009/053276

§ 371 Date: May 13, 2011

(30) Foreign Application Priority Data
Jul. 28, 2008 (EP) 08161246.7

(51) Int. Cl. H04R 17/00; B32B 7/02; H04R 1/00

(52) U.S. Cl. 381/190; 428/212; 428/213; 381/150

(57) ABSTRACT

A membrane for an acoustic transducer is provided which comprises a first portion having a first stiffness, and a second portion comprising a first subsection having a second stiffness and a second subsection having a third stiffness, wherein the second stiffness and the third stiffness are different.

### FIELD OF THE INVENTION

The invention relates to a membrane for an acoustic transducer.

Moreover, the invention relates to an acoustic transducer.

### BACKGROUND OF THE INVENTION

A wide range of audio systems are known in the prior art. In general most of these audio systems comprising a loudspeaker, or in short speaker, adapted to convert electrical signals into sound waves by inducing an oscillation into a membrane of the speaker. Such a membrane typically has a round shape and consists of a stiff part which is designed to move air, thus generating a sound wave, and a soft part which is designed to allow the movement of the stiff part and seal it against the back of the speaker. As well as loudspeaker having a round shape loudspeaker is known having a more rectangular shape leading to a reduced space or area requirements.

Although there is known a great number of different speaker types there may be a need for an acoustic transducer having improved acoustic qualities.

### SUMMARY OF THE INVENTION

It may be an object of the invention to provide a membrane for an acoustic transducer and an acoustic transducer having improved acoustic qualities and reliability.

In order to achieve the object defined above a membrane for an acoustic transducer and an acoustic transducer according to the independent claim is provided. Advantageous embodiments are described in the dependent claims.

According to an exemplary aspect a membrane for an acoustic transducer is provided which comprises a first portion having a first stiffness, and a second portion comprising a first subsection having a second stiffness and a second subsection having a third stiffness, wherein the second stiffness and the third stiffness are different.

In particular, the first portion may relate to or form a stiff portion of a membrane, i.e. the portion designed or adapted to move air, while the second portion may relate to or form a soft portion of the membrane. In particular, the first stiffness may be greater than at least one of the second stiffness and the third stiffness. Of course the second portion may comprise a greater number of subsections. The first portion and the second portion may be formed by a layered structure, e.g. a multilayer structure or a monolayer structure.

According to an exemplary aspect an acoustic transducer is provided which comprises a membrane according to an exemplary aspect of the invention. In particular, the acoustic transducer may be a loudspeaker having a small thickness, e.g. in the range between 10 μm and 2 mm, preferably about 300 μm. In case of loudspeakers based on MEMS-technology the loudspeakers may have an even smaller thickness in the range of 500 nm to 10 μm, e.g. about 1 μm.

The acoustic transducer may be an element converting any kind of signal, e.g. an electrical signal, into an acoustical signal or vice versa, e.g. a loudspeaker or a microphone.

The term “stiffness” may particular denote a characteristic of an element describing the resistance of the element against deformation or deflection. That is, a material or element having a higher stiffness may have a smaller deflection than a material or element having a smaller stiffness when exposed to the same force trying to deflect or move the element.

The term “membrane” may particularly denote any kind of element adapted or suitable for performing an oscillating movement and thus may be able to generate air movement or sound waves. For example, a conventional textile or cardboard membrane known for long in the field of loudspeakers as well as a layer structure known from piezoelectric loudspeakers. Other possible membrane materials may include any suitable polymer material like polycarbonate.

By providing a second portion of the membrane having different values of stiffness it may be possible to adapt the stiffness values to different lengths of the second portion so that the corresponding mechanical properties of the sides may be equal or so that at least the differences may be reduced compared to a second portion having a constant level of stiffness. Thus, it may be possible to increase the acoustic performance of the acoustic transducer comprising the membrane. It may even be possible to increase the lifetime of the membrane and such of the whole acoustic transducer, since it may be possible to adapt the stiffness of different subsection according to the respective load or strain induced into the specific subsection. Furthermore, it may be possible to adapt the stiffness of the specific subsections to specific stiffness values so that the oscillation deviation may be equal or at least substantially equal for all subsection independent of the length of the same or the material or geometry used for the same. Thus, it may be possible to ensure that not a specific subsection, e.g. one side of a polygonal membrane, is limiting for the displacement.

Thus, a gist of an exemplary aspect of the invention may be seen in providing a membrane for an acoustic transducer comprising two portions, wherein one portion is divided into at least two subsections having different stiffness level and wherein the other portion may form the stiff part of a membrane. By accordingly choosing the stiffness level of the different subsections it may be possible to ensure that the performance of the acoustic transducer is increased even in the case that the membrane is not of circular shape.

In the following, further exemplary embodiments of the membrane for an acoustic transducer will be explained. However, these embodiments also apply to the acoustic transducer.

According to another exemplary embodiment of the membrane the second portion is arranged circumferential with respect to the membrane.

In particular, the first subsection and the second subsection may be arranged subsequently along the circumference of the membrane. That is, the two subsections may be arranged in a way that both are arranged at equal distance to a centre of the membrane, i.e. no inner subsection and no outer subsection is provided. Contrary to that, the first portion may be arranged closer to the centre of the membrane than the second portion.

The term “circumference” may particularly denote the periphery of an object, e.g. membrane, having any shape. In particular, the term may not be restricted to circular or elliptical shapes but may also characterize the edge or boundary of objects having a polygonal shape.

According to another exemplary embodiment of the membrane the second stiffness and the third stiffness are chosen in such a way that a restoring force is equal for the first subsection and the second subsection.

The term “restoring force” may particularly denote a force implied to a specific element, e.g. membrane, when it is deflected out of its rest position. For example, in case a rectangular shape of the membrane different parts of the membrane, e.g. a longer side and the shorter side, may be exposed to different restoring forces in case the respective subsections have the same stiffness.

According to another exemplary embodiment of the membrane the membrane has a non circular shape; in particular, the membrane may have a shape comprising at least one angle.

For example, the membrane may have a substantially polygonal shape, e.g. a rectangular shape, a square shape, or a honeycomb shape. However, any shape or geometry of the membrane may be suitable, e.g. every geometry showing sides of different lengths including straight or curved borders or edges.

According to another exemplary embodiment of the membrane the membrane has a rectangular shape.

In particular, a short side of the rectangle may form the first subsection while a long side of the rectangle may form the second subsection. However, each side may also comprise several subsections. In general the shorter side may correspond to the subsection having a higher stiffness than the longer side.

According to another exemplary embodiment of the membrane the first subsection comprises a first material, and the second subsection comprises a second material, wherein the first material has a first stiffness, while the second material has a second stiffness different from the first stiffness.

That is, the first and the second subsection may be formed of materials having different stiffness so that the subsections have different stiffness.

According to another exemplary embodiment of the membrane the first subsection has a first thickness and the second subsection has a second thickness, wherein the first thickness is different from the second thickness. That is, the first and the second subsection may be formed to have different thicknesses so that the subsections have different stiffness.

According to another exemplary embodiment of the membrane the subsection having the greater thickness comprises an additional layer. That is, it may be possible to achieve the greater thickness of one of the subsections by attaching, e.g. gluing, or depositing an additional material layer in the respective subsection. By adding such an additional layer it may be possible to provide an easy way to ensure different stiffness for the different subsections of the second portion.

According to another exemplary embodiment of the membrane the first subsection and the second subsection comprise a common layer and the subsection having the greater stiffness comprises an additional layer. That is, it may be possible to form the second portion by a common layer and to achieve the greater stiffness of one of the subsections by attaching, e.g. gluing, or depositing an additional layer to the common layer in the respective subsection. In particular, the whole second portion may comprise a common structure, e.g. a single common layer or a common multilayer structure, while one, the stiffer subsection, may comprise an additional layer leading to an increased stiffness compared to the other subsection not comprising the additional layer.

In addition the first and second subsection may also comprise or may consist of different materials. The different thicknesses may be provided by attaching an additional layer in the sections which are intended to exhibit the higher stiffness. In particular, the first subsection may be formed by a first layer while in the second subsection an additional layer is attached to the first layer. For example, the first layer may be formed to have a stiffness between 50 MPa and 250 MPa, preferably about 100 MPa, and a thickness between 10 μm and 250 μm, preferably about 30 μm, while the additional layer may be a foil formed to have a stiffness between 1500 MPa and 5000 MPa, preferably about 3000 MPa, and a thickness between 10 μm and 50 μm, preferably about 30 μm.

According to another exemplary embodiment of the membrane the first subsection has a first cross-section and the second subsection has a second cross-section which is different from the first cross-section.

In particular, it should be noted that this difference in cross-section is a given along the circumference of the second part and not in a radial direction, i.e. the cross section changes along the circumference of the membrane. For example, this difference has to be distinguished from a circumferential bulge formed in case of a circular membrane.

In the following, further exemplary embodiments of the acoustic transducer will be explained. However, these embodiments also apply to the membrane.

According to another exemplary embodiment the acoustic transducer further comprises an actuating unit, wherein the actuating unit is adapted to apply a force to the membrane.

According to another exemplary embodiment of the acoustic transducer the actuating unit comprises a magnet system. In particular, the magnet system may comprise a magnet and a coil. The coil may be fixed to the membrane and may be adapted to interact with the magnet. Thus, an actuating system may be formed comprising a magnet, preferably fixed to a structure or frame of the loudspeaker, and a coil, preferably fixed to the membrane. In this way an acoustic transducer may be provided wherein the deflection of the membrane is caused by an electromagnetic force, e.g. the Lorentz force.

According to another exemplary embodiment of the acoustic transducer the actuating unit comprises a piezoelectric element. Thus, a piezoelectric acoustic transducer may be provided.

Summarizing an exemplary aspect of the invention may be seen to provide a membrane for a loudspeaker or microphone comprising two different portions, i.e. a stiff portion adapted to generate air movement and a soft or flexible portion adapted to enable the movement of the stiff portion. The flexible portion may be divided into a plurality of subsections and may have, as the whole membrane, a polygonal shape, e.g. a rectangular shape. The different subsections may have a corresponding stiffness level each of which is adapted that each subsection provides the same resistance to an oscillating movement of the stiff portion. Thus, it may be possible to ensure that the performance of the membrane and the loudspeaker may be increased even for rectangular shapes.

The stiffness level and thus the compliance of the membrane may be selectively influenced by different parameters, e.g. its thickness, the materials geometry and/or other measures of the different subsections of the flexible portion. In particular, it may be possible to alter or adapt more than one of the above parameters in order to achieve an optimal performance of the loudspeaker. It should further be noted that the compliance of a side of a polygonal or rectangular shape may be influenced when only part of it, i.e. a subsection, is made of another material or has another thickness or geometry.

According to the present invention speakers may include electro-dynamical speakers, i.e. speakers which are based on deflection of the membrane by using Lorentz force between a coil fixed to the membrane and a magnet fixed to a structure or frame of the loudspeaker. However, it may also include speakers with different types of actuators, e.g.

piezoelectric speakers, and in particular to any type of rectangular speakers, i.e. to membranes having sides with different lengths as well as speakers having a combination of straight and curved borders.

Therefore, an aspect of the invention may be to design different sides of a rectangular speaker membrane in different ways to possibly overcome the differences which arise from their different lengths.

The exemplary embodiments and aspects defined above and further aspects of the invention are apparent from the examples of embodiment to be described hereinafter and are explained with reference to these examples of embodiment. Features which are described in the connection with one exemplary embodiment or exemplary aspect may be combined with features of another exemplary embodiments or aspects.

### BRIEF DESCRIPTION OF THE DRAWINGS

The invention will be described in more detail hereinafter with reference to examples of embodiment but to which the invention is not limited.

FIG. 1 schematically illustrates a rectangular membrane having two portions.

FIGS. 2a-b schematically illustrate rectangular membranes having a portion with several subsections.

### DESCRIPTION OF EMBODIMENTS

The illustration in the drawing is schematically. In different drawings, similar or identical elements are provided with the similar or identical reference signs.

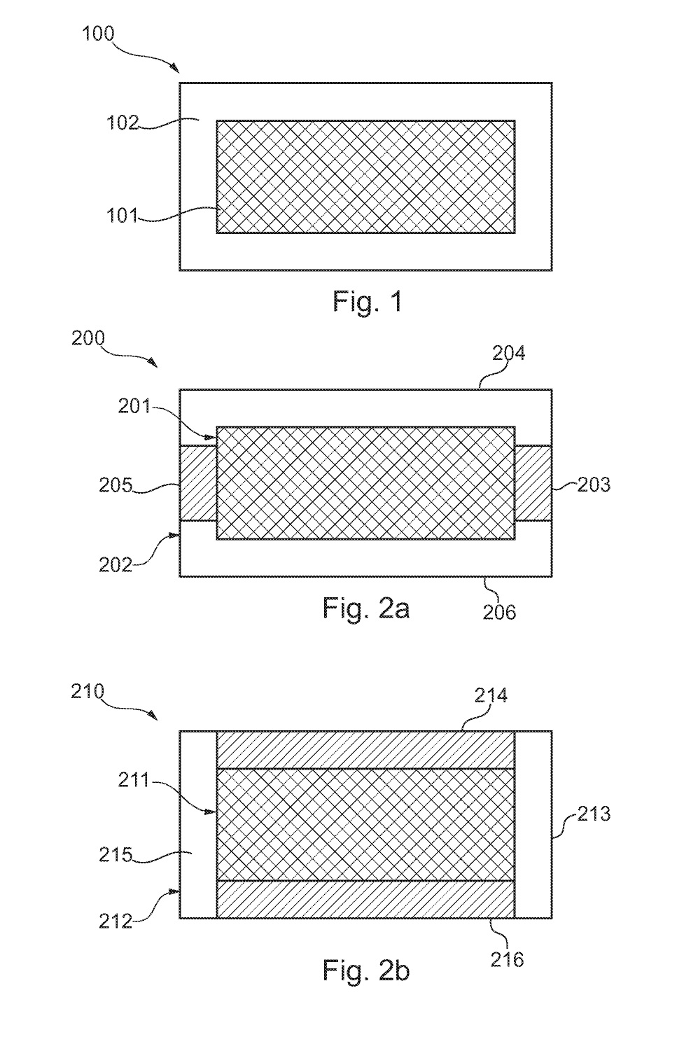

In the following, referring to FIGS. 1 to 2 a membrane according to exemplary embodiments will be explained.

FIG. 1 schematically shows a general layout of a membrane for a loudspeaker 100. The loudspeaker 100 has a rectangular shape and comprises a first or central portion 101 and a second or outer portion 102. The central portion is formed by a stiff material enabling that the central portion generates air movements in case the central portion oscillates. The outer portion 102 is formed in such a way that the movement of the central portion 101 is enabled while still allowing fixing the membrane to a rigid frame or structure. That is, the second portion 102 is a flexible portion providing a lower stiffness than the central portion 101.

FIG. 2 schematically shows rectangular membranes having a portion with several subsections. In particular, FIG. 2a shows a membrane 200 having a central stiff portion 201 and an outer flexible portion 202. However, contrary to the membrane 100 shown in FIG. 1 the outer portion comprises four subsections 203, 204, 205, and 206, wherein the first and third subsections 203 and 205 substantially relate to the short sides of the rectangle while the second and fourth subsections 204 and 206 substantially relate to the long sides of the rectangle. As indicated by the different hatching of the first and third subsections compared to the second and fourth subsections these sections have different stiffness. In particular, the short subsections 203 and 205 are formed to have a higher stiffness compared to the longer subsections 204 and 206. For example, this can be achieved by forming a second portion by one layer and attach an additional layer or film to the first and third subsection, i.e. to the subsection intended to exhibit the higher stiffness. The one layer may be a base layer having a thickness of about 30 μm and a stiffness of about 100 MPa, while the additional layer may be formed by using a foil having a thickness of about 30 μm and a stiffness of about 3000 MPa. However, the different stiffness level may also be achieved by using different materials of the same thickness, different thicknesses of the same material, different geometries and/or cross sections along the circumference of the membrane, or a combination of the above techniques.

FIG. 2b shows a similar membrane 210 having a central stiff portion 211 and an outer flexible portion 212 than the one shown in FIG. 2a. However, contrary to the membrane 200 of FIG. 2a the stiffness of the longer sides or the second subsection 214 and 216 are reduced compared to stiffness level of the shorter sides 213 and 215. This may be done by thinning the respective second and fourth subsections or by using different materials or geometries.

It should be noted that the term “comprising” does not exclude other elements or features and the “a” or “an” does not exclude a plurality. Also elements described in association with different embodiments or aspects may be combined. It should also be noted that reference signs in the claims shall not be construed as limiting the scope of the claims.

1. A membrane comprising:
a first portion having a first stiffness, and
a second portion comprising a first subsection having a second stiffness and a second subsection having a third stiffness, wherein the second stiffness and the third stiffness are different.

2. The membrane according to claim 1, wherein the second portion is arranged with at least a portion circumferential with respect to the membrane.

3. The membrane according to claim 1, wherein the second stiffness and the third stiffness are chosen in such a way that a restoring force is equal for the first subsection and the second subsection.

4. The membrane according to claim 1, wherein the membrane has a non circular shape.

5. The membrane according to claim 4, wherein the membrane has a rectangular shape.

6. The membrane according to claim 1, wherein the first subsection comprises a first material, and the second subsection comprises a second material, wherein the first material has a first stiffness, and the second material has a second stiffness different from the first stiffness.

7. The membrane according to claim 1, wherein the first subsection has a first thickness and the second subsection has a second thickness, wherein the first thickness is different from the second thickness.

8. The membrane according to claim 7, wherein the subsection having the greater thickness comprises an additional layer.

9. The membrane according to claim 1,
wherein the first subsection and the second subsection comprise a common layer, and
wherein the first subsection and the second subsection comprise a common layer and the subsection having the greater stiffness comprises an additional layer.

10. The membrane according to claim 1,
wherein the first subsection has a first cross-section,
wherein the second subsection has a second cross-section which is different from the first cross-section.

11. An acoustic transducer comprising a membrane according to claim 1.

12. The acoustic transducer according to claim 11, further comprising:
an actuating unit,
wherein the actuating unit is adapted to apply a force to the membrane.

13. The acoustic transducer according to claim 12, wherein the actuating unit comprises a magnet system.

14. The acoustic transducer according to claim 12, wherein the actuating unit comprises a piezoelectric element.
